(19) United States
(12) Patent Application Publication
(10) Pub. No.: US 2019/0257124 A1
(43) Pub. Date: Aug. 22, 2019

(54) Handle Unit for a Moveable Part of a Vehicle

(71) Applicant: Huf Hülsbeck & Fürst GmbH & Co. KG, Velbert (DE)

(72) Inventors: Matthias Löw, Ratingen (DE); Willi Put, Winterswijk-Meddo (NL)

(21) Appl. No.: 16/308,652

(22) PCT Filed: May 16, 2017
(86) PCT No.: PCT/EP2017/061744

§ 371 Date: Dec. 10, 2018

(30) Foreign Application Priority Data
Jun. 13, 2016 (DE) 10 2016 007 112.5

(51) Int. Cl. E05B 85/10

(52) U.S. Cl. CPC E05B 85/103

(57) ABSTRACT

The present invention relates to Handle unit (10) for a moveable part (110) of a vehicle (100), comprising a locking cylinder (20) and a moveably-mounted handle portion (11) with a housing (11.1), wherein the handle portion (11) can at least be brought into a rest position (I), in which the handle portion (11) is arranged flush with an outer surface (111) of the vehicle (100), and into an operating position (II), in which the handle portion (11) is at least sectionally arranged spaced apart from the outer surface (111) and can be grasped by a user.

The present invention relates to a handle unit for a moveable part of a vehicle according to the independent device claim as well as a door handle system for a vehicle according to the independent system claim.

Handle units arranged flush on a moveable part of a vehicle are known, and wherein a pleasant optical appearance of the external surface of a moveable part of the vehicle is enabled. The disadvantage in generic handle units lies with the strictly-electronic configuration required for the actuation of the handle unit, and thus for the opening of the moveable part of the vehicle. This requires a strictly-electronic locking system in order to be able to fulfill the opening request of the operator. In the case of a malfunctioning of the strictly electronic locking system, an opening of the moveable part can be performed only with huge efforts.

The object of the present invention is to at least partially resolve the above-mentioned disadvantages known from the prior art. In particular, the object of the present invention is to provide a handle unit, which enables a mechanical actuation of the locking system and, at the same time, enables an optically-pleasant appearance of a moveable part of a vehicle.

The above object is achieved by means of a handle unit having the features of the independent device claim, as well as by a door handle system in accordance with the independent system claim.

Further features and details result from the dependent claims, the description and the drawings. Features and details described in conjunction with the device according to the invention naturally also apply in conjunction with the system according to the invention, and vice versa, so that with respect to the disclosure, reference is or can always mutually be made to the individual aspects of the invention.

Advantageous developments and improvements of the subject-matters indicated in the independent claims are enabled by the measures indicated in the dependent claims.

According to the invention, the handle unit for a moveable part of a vehicle comprises a locking cylinder and a moveably-mounted handle portion with a housing. The handle portion can at least be brought into a rest position, in which the handle portion is arranged flush with an outer surface of the vehicle, and into an operating position, in which the handle portion is at least partially arranged spaced apart from the outer surface and can be grasped by a user. In the context of the invention, a moveable part particular refers to a door, a tailgate, a hood, or a fuel filler flap. A locking cylinder according to the invention preferably serves for an emergency actuation, which allows opening of the moveable part in the event of a failure of the electronic and/or electromechanical lock system. Thereby, the locking cylinder can be operated with a tool, in particular a key or the like, thus unlocking and/or locking the lock system. According to the invention, the lock system comprises a moveably-mounted handle portion with a housing, wherein the housing can be formed to be hollow or solid, and the handle portion can at least be translated into a rest position or an operating position. In the rest position, the handle portion is arranged flush with the outer surface of the moveable part of the vehicle, wherein it can be provided that a trim can be arranged on a side of the housing of the handle portion facing away from the vehicle, which trim is arrangeable flush with the outer surface. It can be provided that in the rest position, the handle portion is arranged flush with an outer surface in such a way that an actuation of the handle portion by a user is prevented in that the grip section is inaccessible by the flush-fitting arrangement when it is gripped or grasped behind it. Only in the operating position, the handle portion is spaced from the outer surface in such a way that the operator can grasp or reach behind the handle portion of the handle unit with one hand. Preferably, the locking cylinder is arranged in a region of the moveably-mounted handle portion.

In the scope of the invention, the locking cylinder, in the rest position, can be covered by the handle portion, in particular be not accessible from outside. The moveably-mounted handle portion and/or a trim arranged on the handle portion or on the housing of the handle portion can be correspondingly dimensioned such that at least in the rest position, the locking cylinder is covered by the handle portion and/or the trim of the handle portion from a side facing away from the vehicle outer surface. In the rest position of the handle portion, the locking cylinder is thus not visible from outside, wherein particularly the locking cylinder is covered by the flush handle portion. Advantageously, the locking cylinder is covered by the handle portion or the housing and/or the trim of the handle portion, in the rest position, in such a way that it is not accessible from outside. In this way, the locking cylinder is protected from external influence of the surroundings and/or manipulation attempts. At the same time, in the rest position of the handle portion, a locking cylinder cannot be discerned from outside, which would otherwise result in that non-authorized persons are encouraged to make manipulation attempts due to the mechanical locking cylinder.

Advantageously, the handle portion may comprise an access opening, whereby the locking cylinder is accessible from outside at least in the operating position, wherein a cover element is arrangeable in particular on the access opening, so that the access opening can be closed by the cover element. As a consequence, the locking cylinder is not accessible from outside in the rest position, but can be accessible with the translation of the handle portion into the operating position, wherein in particular the access opening can allow or facilitate access to the locking cylinder. Thus, in the event of a failure or in an emergency situation, the operator can actuate the locking cylinder via the access opening using a tool, in particular a key or the like. In this case, the access opening is arranged on the handle portion, in particular on the housing of the handle portion, in such a way that the outer surface of the handle portion or of the housing of the handle portion is not optically impaired, so that the handle portion allows a pleasant optical appearance even in the operating position. It is preferable if a cover element is arrangeable on the access opening of the handle portion, so that the access opening can be closed by the cover element. In this way, it is made possible that an access to the locking cylinder via the access opening of the handle portion is made possible and, at the same time, the locking cylinder is not visible from outside due to the cover element, even in the operating position. In the case that the cover element is located on the handle portion, in particular on the housing of the handle portion, the access opening is closed by the cover element in such a way that the locking cylinder is not visible and not accessible from outside. As a result, it can be achieved that the locking cylinder is protected against external influence from the surroundings, manipulation attempts or the like, and does not allow any non-authorized third party to take a look at the locking cylinder. In this way, a non-authorized person may not be motivated to do a manipulation of the locking cylinder after all. To that end, the cover element can preferably be configured in such a way that the optically-pleasant appearance of the handle portion, in particular of the housing of the handle portion, is not interrupted by the cover element. Accordingly, the cover element can preferably be adapted visually to the handle portion of the handle unit.

It is furthermore conceivable that the cover element at least sectionally surrounds the locking cylinder at least in the rest position. To that end, the locking cylinder can be arranged on the handle unit in such a way that a free space and/or a guidance is arranged in the region of the locking cylinder, so that the cover element, at least in the rest position, at least sectionally surrounds the locking cylinder within the free space or the guidance. Incidentally, in the case of a cylindrically-formed locking cylinder, for example, the locking cylinder can sectionally be surrounded at least along the outer surface of the cylinder by the cover element. In a movement of the handle portion from the rest position to the operating position, the cover element can at least sectionally move into or out of the free space or the guidance in the region of the locking cylinder. Correspondingly, the cover element is arranged in a region within the moveable part, at least in the rest position, which region is located behind the outer surface of the vehicle, when viewed from outside. Preferably, the cover element is dimensioned such that upon reaching the handle portion in the operating position, the cover element is removable from the access opening from outside.

In the scope of the invention, the handle portion can be brought from an operating position to an actuating position, wherein the cover element is releasable from the housing of the handle portion in the actuating position and/or in the operating position. It is conceivable here that the locking cylinder is at least partially surrounded by the cover element in the actuating position as well. The actuating position can, according to the invention, be reached in that the operator applies a force on to the handle portion from the operating position in such a way that the handle portion preferably moves farther away from the outer surface of the vehicle in the direction away from the vehicle. It can be provided here that the operator grips or grasps behind the handle portion and pulls on it, so that the handle portion is moved from an operating position into the actuating position. This actuation may correspond to an actuation of a door handle conventionally arranged on an outer surface of the moveable part. Thus, by an actuation of the handle portion from an operating position into the actuating position, an opening request of an operator to open the moveable part can be carried out. In this case, the handle unit or the handle portion can be operatively connected to the lock mechanism of the moveable part, so that the lock mechanism is actuated or unlocked when the handle portion is transferred from the operating position to the actuating position. According to the invention, the cover element can be releasable from the housing of the handle portion in the actuating position and in the operating position. Here, releasable can also refer to the fact of being reversibly performable, so that the cover element can be re-arranged by the operator after the removal from the housing of the handle portion that the access opening can be closed. In the case that access to the access opening is requested by the operator, e.g. in case of failure and/or emergency, the operator moves the handle portion into the actuating position and/or into the operating position, allowing access to the cover element. If the operator removes the cover element from the housing of the handle portion now, access to the locking cylinder is granted, and an operator can mechanically actuate the locking cylinder using a tool, in particular a key.

The access opening according to the invention preferably can be arranged on a broadside of the handle portion. In the context of the invention, the broadside of the handle portion is to refer to a part which is not discernable in a front top view of the outer surface of the moveable part. Correspondingly, this is the part of the handle portion which is not arranged flush with the outer surface of the moveable part, on which, for example, a trim can also be arranged. Thus, the broadside describes the surface extending into the moveable part, wherein only upon transfer of the handle portion into the operating position and/or into the actuating position, access is made possible by at least one portion of this broadside. The access opening, which is arranged on the broadside of the handle portion, allows realizing an optically pleasant appearance and, at the same time, enabling access to the locking cylinder via the access opening. The access opening is preferably only sectionally arranged on the broadside of the handle portion, so that the cover element closes the access opening. Preferably, the access opening is arranged spaced apart from the surface of the handle portion, which is arrangeable flush with the outer recess of the moveable part. The distance between the part of the handle portion, in particular of the housing and/or a trim, to the access opening can preferably be between approximately 1 mm and approximately 20 mm, preferably between approximately 3 mm and approximately 15 mm, particularly preferably between approximately 5 mm and approximately 10 mm.

It is furthermore conceivable that the cover element comprises at least one latch connection and/or a clip connection, whereby a force-fit connection with the housing of the handle portion can be created, wherein in particular the cover element is formed essentially U-shaped. The cover element can thus be brought into engagement with the housing of the handle portion by means of the latch connection and/or the clip connection in such a way that the cover element will not unintentionally unblock the access opening in particular when moved from the rest position into the operating position or actuating position and/or vice versa. Thus, a force-fit connection between the housing of the handle portion and of the cover element can be created via the latch connection and/or the clip connection. To that end, the cover element and/or the housing of the handle portion may comprise latch protrusions and correspondingly formed counter-holding means, which are being engaged with the housing of the handle portion when closing the cover element. Preferably, the force-fit connection can be released again in a nondestructive manner, so that access is provided to the operator by releasing the force-fit connection. Preferably, the cover element is configured essentially U-shaped, wherein the cover element is configured U-shaped in such a way that the shape is adapted to the jacket of the housing of the handle portion. In the context of the invention, U-shaped can not only mean directly circular in the type of a circular segment, but it can also mean that the cover element is trapezoidal and comprises at least two legs, which can be brought into a force-fit connection with the housing of the handle portion. It is furthermore conceivable that the cover element comprises a pivot mechanism, whereby the cover element is moveable in a translatory and/or rotary manner and the access opening can thus be unblocked and/or blocked. Here, a pivot axis and a guide groove can be arranged on the cover element and/or on the housing of the handle portion in the region of the access opening, wherein the pivot axis is moveably mounted within the guide groove. It is conceivable that the cover element, in a first step, can be pulled-off from the housing of the handle portion in a translatory manner, preferably after a release of the force-fit connection, and after that, is moved along the pivot axis in such a way that the access opening is at least sectionally released, so that access to the locking cylinder is made possible. Preferably, the pivot axis is arranged on the cover element, and a guide groove is formed in the housing of the handle portion, wherein the guide groove can be dimensioned in such a way that a pivoting about the pivot axis is made possible after releasing the latch connection of the cover element. Here, the pivot mechanism can accordingly be formed as a push or pull and fold mechanism. Thus, such a push-fold mechanism enables a simple unblocking of the access opening and, at the same time, prevents a detachment of the cover element, in particular after displacing the cover element into an open position where the access opening is unblocked.

According to the invention, the handle portion may comprise a handle recess or a reach-through opening. A handle recess thus describes a cavity inside the housing of the handle portion, wherein the handle recess is preferably dimensioned in such a way that the operator can reach, with their hand, at least with a plurality of fingers, into the handle recess and thus grasp the handle portion. It is furthermore conceivable that the handle portion comprises a reach-through opening, wherein a reach-through opening means that the housing has a material cut-out which can be reached-through, for example with a hand of the operator, so that a grasping around the handle portion by the operator is made possible, for example.

The handle portion according to the invention and/or the cover element according to the invention can be an injection molded plastic part, in particular a 2-component injection molded plastic part. As a result, a cost-efficient and effort-low production of the handle portion and/or of the cover element can be achieved. At the same time, it is possible to design the handle portion and/or the cover element geometrically and optically in various ways by means of an injection molding process. In the 2-component injection molded part, it can furthermore be made possible that less exposed portions of the handle portion and/or of the cover element comprise a less durable and cheaper plastic material than portions of the handle portion and/or of the cover element, which are subjected to a higher load for example by mechanical and/or external influences. It is furthermore conceivable that the handle portion and/or the cover element comprise a polyamide, preferably PA6, wherein it can be provided, in particular, that the handle portion and/or the cover element is painted and/or dyed.

In the scope of the invention, the cover element can be arranged flush with the housing. Preferably, the cover element is connected flush, preferably form-fit and/or force-fit with the housing. In this case, the cover element can latch with the housing of the handle portion, for example via a latch connection and/or a clip connection and/or a pivot mechanism. It is likewise conceivable that the cover element is slid onto the housing or the housing portion of the handle portion in such a way that if the shape of the cover element is formed correspondingly, said element can be arranged flush with the handle portion or the housing of the handle portion when the access opening is closed with the cover element.

Advantageously, a handle mechanism can be provided, whereby the handle portion is moveable translatory or along a circular path, in particular parallel to the outer surface of the moveable part, wherein in particular the handle mechanism comprises at least two mounting points on which the handle portion is moveably mounted. The handle mechanism is arranged on the handle portion in such a way that it is at least sectionally arranged within the moveable part and, if the operator has an operating wish, said handle mechanism moves the handle portion, via a translatory movement and/or a movement effected along a circular path, in particular moves the handle portion parallel to the outer surface, into the operating position and/or the actuating position. It can be provided here that the handle is displaced into the operating position and/or the actuating position via the handle mechanism, when an ID transponder, carried along by the operator, transmits a corresponding signal to the security system of the vehicle and enables the opening request of the operator, such that the handle portion can be actuated by the operator. Furthermore, it is conceivable that the handle mechanism is formed in such a way that the handle portion can be transferred back into the rest position via the handle mechanism, so that the handle portion is displaced back into the rest position via the handle mechanism upon a signal for locking the vehicle, in particular from a central locking mechanism of the vehicle. The handle portion can be moved in a translatory manner between the rest position, the operating position and/or the actuating position. Here, the translatory movement can correspond to the movement of a CD, DVD, or Blu-ray drive. Furthermore, it is conceivable that the handle portion can be moved along a circular path or a path of a circular segment or in a trapezoidal manner or along a parallelogram into the operating position, the actuating position and/or the rest position. Preferably, the handle mechanism comprises two mounting points to that end, on which the handle portion is moveably mounted. The mounting points can preferably be arranged in the handle portion, in particular in the housing of the handle portion and/or of the moveable part, in such a way that it is protected against external influences and/or manipulation attempts.

Furthermore, it is conceivable that at least one sensor is in particular provided on the handle portion. Furthermore, a further sensor can be arranged on the moveable part, in particular in the region of the handle unit. A sensor according to the invention is particularly configured as a proximity sensor, so that an approach of a user, in particular of a hand of the user, to the handle portion can be detected, wherein the sensor is in particular in signal connection with a security system of the vehicle. The sensor may serve to detect an opening request of the user, or to unlock and/or lock the locking mechanism of the moveable part. Furthermore, it is conceivable that the at least one sensor is arranged in the region of the handle recess and/or of the handle portion. Thus, the lock is unlocked only upon grasping into or reaching through into the handle recess or the reach-through opening, for example. Moreover, it is conceivable that at least one sensor detects a gesture of the operator in the region of a recognition region of the sensor. The gesture can be opening gestures, closing gestures or gestures for activation of an alarm system of the vehicle.

Advantageously, at least one opening aid can be arranged on the cover element, whereby a simplified removal of the cover element from the housing of the handle portion is enabled. An opening aid according to the invention can e.g. be a portion on the cover element, which comprises a surface that has corrugations or a roughened surface, so that a slipping of a hand of the operator in an attempt to remove the cover element is prevented essentially. Furthermore, the cover element may comprise recess-shaped portions, so that a finger, in particular a fingertip of an operator, can reach inside such a recess so that an improved transmission of force for the removal of the cover element is enabled. Furthermore, the opening aid can be a recess of the cover element, into which recess a key, which is preferably also provided for the locking cylinder, can be inserted, wherein either by a lifting effect of the key on the recess of the cap the cover element can be removed, or by the engagement of the key into the recess a latch connection and/or clip connection can be released. Accordingly, the force-fit and/or form-fit connection of the cover element with the housing of the handle portion can be released more easily by an opening aid according to the invention.

In the scope of the invention, the handle mechanism may comprise a push-push mechanism, whereby the handle portion can be mechanically brought from the rest position into the operating position and/or the actuating position and vice versa. In this case, the push-push mechanism may comprise a spring, for example, and a heart cam mechanism, wherein the spring is moved in a heart cam mechanism upon actuation of the push-push mechanism so that by the pushing of the handle portion, this handle portion is both extended and retracted. In particular, such a push-push mechanism is advantageous in the case that the electrics of the vehicle has failed and the handle unit, in particular the handle portion, can manually be brought into an operating and/or actuating position by the user. In this case, for example by a slight pushing of the handle portion in the direction of the vehicle interior, this portion can be translated into the operating and/or actuating position via the push-push mechanism. Furthermore, it is conceivable that the push-push mechanism can comprise at least one electromechanical switch element, wherein the electromechanical switch element can be brought from a first mode to a second mode by actuation, in particular by a push movement, on to the handle portion, so that in the first mode, the electromechanical switch element senses an actuation by the actuation means, and in the second mode, the electromechanical switch element unblocks the handle portion in such a way that this portion can be moved in the direction of the operating position and/or actuating position. In this case, a heart cam mechanism can be dispensed with in the push-push mechanism, which enables a further cost reduction and an increase of the reliability and durability. The electromechanical switch element can comprise an electroactive polymer, a shape memory alloy, or a piezo element, for example. These actors belonging to the category of artificial muscles are distinguished in that the materials employed function both as a sensor and as actuator. Accordingly, such an electromechanical switch element allows both, sensing an opening request and releasing the handle unit or the handle portion.

According to the invention, the cover element can comprise a securing element, whereby the cover element is mechanically connected to the handle portion and/or the moveable part. The securing element preferably serves to that the cover element will not detach, in particular after the removal from the handle portion, but is held on the handle portion and/or the moveable part by the securing element. The securing element can, for example, be formed in the form of a connection means such as a wire or a flexible connection, in particular made of plastic.

In the scope of the invention, a sealing element can be provided, wherein in particular the sealing element is arranged on the handle portion and/or on the moveable part in such a way that the handle portion is sealed with respect to the outer surface and closed. By the sealing element, the handle mechanism as well as all internal components of the handle unit can be protected against external influences when the handle portion is in the rest position. In this way, the intrusion of moisture, e.g. in the form due to rain, snow or washing plants, can be prevented essentially due to the sealing element. Furthermore, it is conceivable, according to the invention, that the cover element comprises a sealing element so that the sealing element is sealed and closed with the handle portion, in particular the housing of the handle portion.

According to the invention, a locking cylinder can be provided, wherein the locking cylinder is at least arranged sectionally in the access opening, in particular is accessible via the access opening and covered by the housing of the handle portion in the rest position. The locking cylinder enables in particular a mechanical and/or electromechanical locking/unlocking of a locking system of a moveable part of a vehicle. The locking cylinder is, according to the invention, at least sectionally arranged in the access opening and can thus be reached or actuated through or via the access opening. In particular, the locking cylinder is, at least in the rest position, covered by the housing of the handle portion, in particular not accessible. Accordingly, an optically pleasant appearance is created, and an intrusion of moisture, e.g. in the form of rain, snow or washing plants can essentially be prevented.

It is furthermore conceivable that a stop element is provided, wherein the handle portion contacts the stop element at least sectionally in the rest position, in particular the stop element comprises a sensor, whereby the position of the handle portion can be sensed. Preferably, the stop element is arranged in the region of the locking cylinder. The stop element can for example have a circular, i.e. cylindrical, rectangular, in particular prismatic design, wherein, in particular, the stop element is dimensioned such that the handle portion or the housing of the handle portion contacts the stop element before a contact of the housing of the handle portion with the locking cylinder would be achievable. Preferably, at least one sensor can be arranged on the stop element, whereby the position of the handle portion can be sensed. This can be a capacitive and/or inductive sensor, wherein a position of the handle, in particular of the rest position, operating position, or actuating position can be sensed by the handle portion approaching and/or distancing from the stop element, and thus from the sensor.

Advantageously, the side of the handle portion facing away from the vehicle can be arrangeable spaced apart from the outer surface by between approximately 10 mm and approximately 75 mm, preferably between approximately 20 mm and approximately 55 mm, particularly preferable between approximately 30 mm and approximately 45 mm. In particular, the handle portion, in the actuating position, can be arrangeable spaced apart from the outer surface by between approximately 20 mm and approximately 100 mm, preferably between approximately 30 mm and approximately 80 mm, particularly preferable between approximately 40 mm and approximately 50 mm. Accordingly, the handle portion is in the actuating position in a position farther distanced from the outer surface compared to the operating position.

According to a further aspect of the invention, a door handle system for a vehicle with at least one handle unit according to the invention and at least one emergency key is claimed, wherein the emergency key is multipart, in particular with a key bit and a key bow, which is in particular designed to be foldable with respect to the key bit. Accordingly, on the one hand, all advantages that have already been described in conjunction with the handle unit according to the invention result.

Moreover, a foldably-formed emergency key enables that the key bit, which is insertable into the locking cylinder, and the key bow are arranged in a manner moveable to one another in order to actuate the key. This allows a particularly compact configuration of the emergency key, wherein the access opening for the locking cylinder in the handle unit or the handle portion can be dimensioned smaller due to the compact design as a result of the folding mechanism of the emergency key. Accordingly, it is sufficient to dimension the access opening in such a way that the key bit and merely a small portion of the key bow are arrangeable in the access opening. The key bit preferably is arranged to be movable at an angle to the key bow, wherein the angle has between approximately 1° and 180°, preferably between 15° and 150°, particularly preferably between 30° and 100°. Thus, the key bow can be inserted into the locking cylinder and the emergency key can lock or unlock the key cylinder particularly by a turn movement via the key bow arranged at an angle relative to the key bit.

Further measures improving the invention result from the following description of some exemplary embodiments of the invention, which are schematically represented in the Figures. All features and/or advantages resulting from the claims, the description or the drawings, including construction details and spatial arrangements, can each per se or in any combination be essential to the invention. It is noted here that the Figures only are of descriptive nature and are not intended to limit the invention in any manner.

In the following Figures, identical reference characters are used for the same technical features, even in different exemplary embodiments.

The above explanation describes the exemplary embodiments exclusively in the scope of examples. Of course, individual features of the embodiments can be combined with one another, if technically feasible, without departing from the scope of the present invention.

The Figures show in:

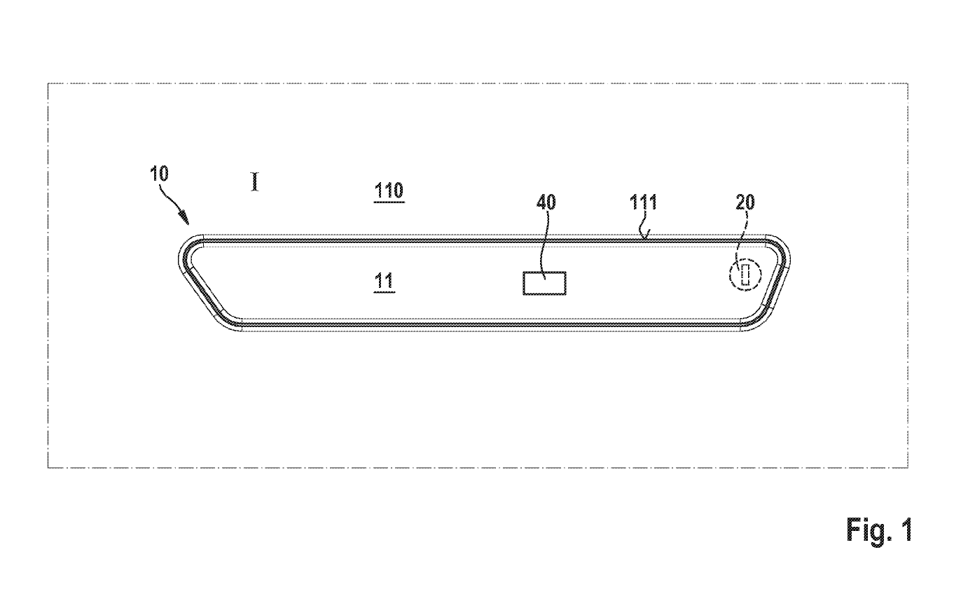

FIG. 1 a first embodiment of the handle unit wherein a handle portion is arranged flush on the outer surface of the movable part,

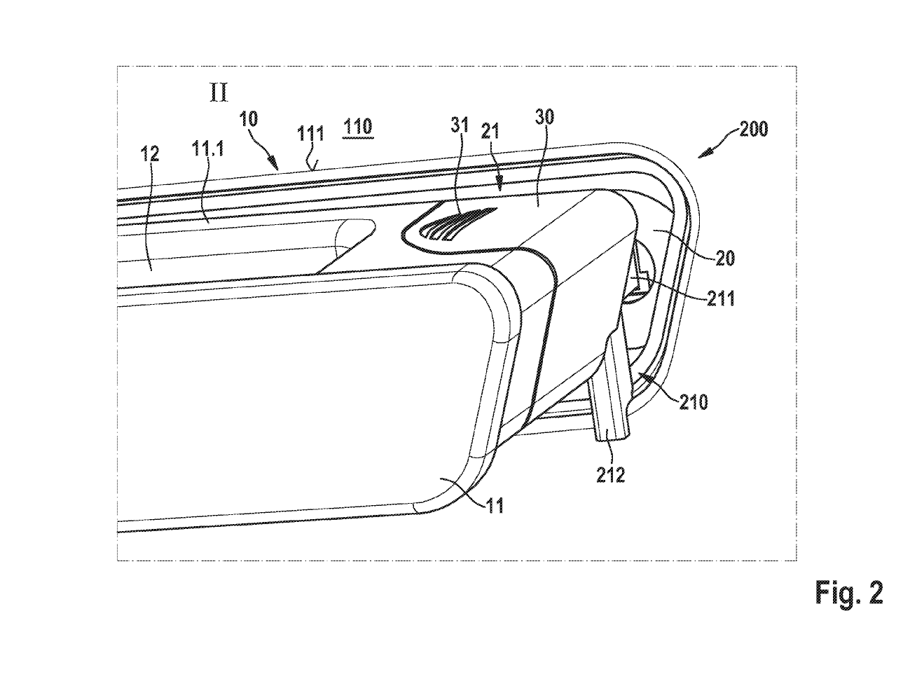

FIG. 2 a detail of a door handle system according to the invention with a handle unit according to the invention,

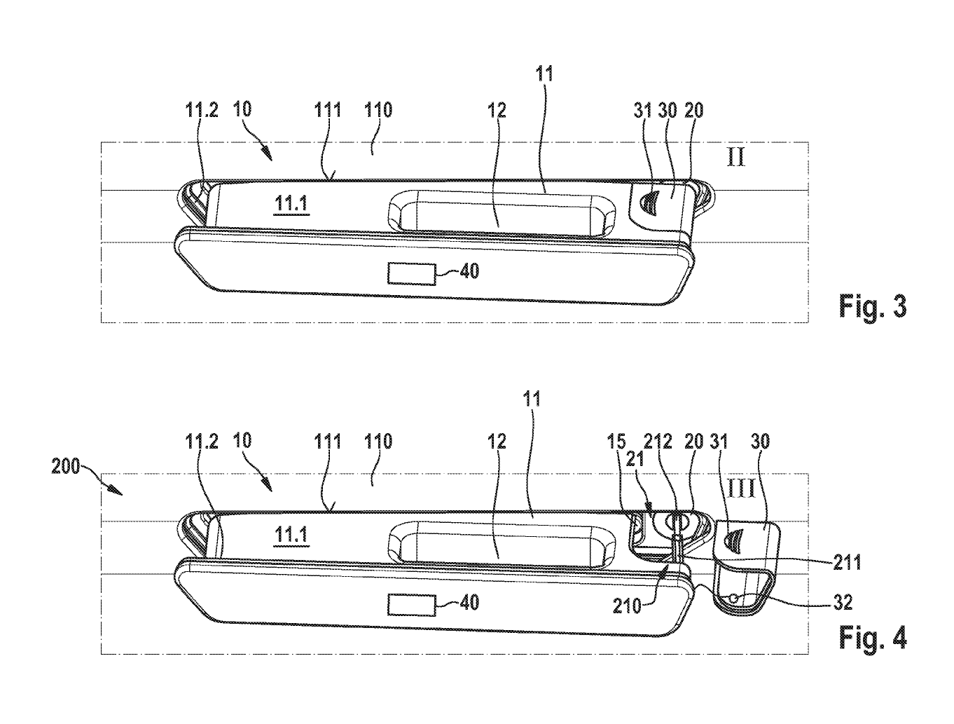

FIG. 3 an embodiment of the handle unit according to the invention in the operating position,

FIG. 4 an embodiment of the handle unit according to the invention in the actuating position,

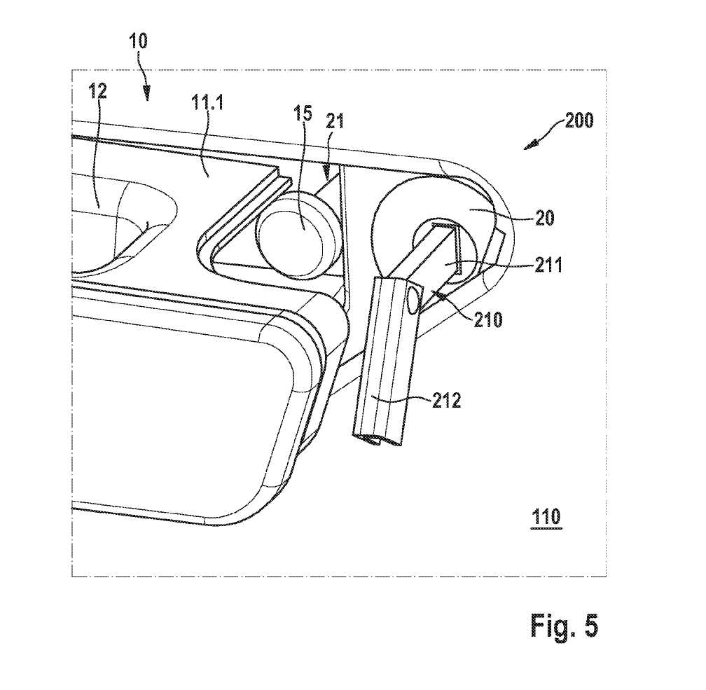

FIG. 5 a detail of another embodiment of the handle unit according to the invention,

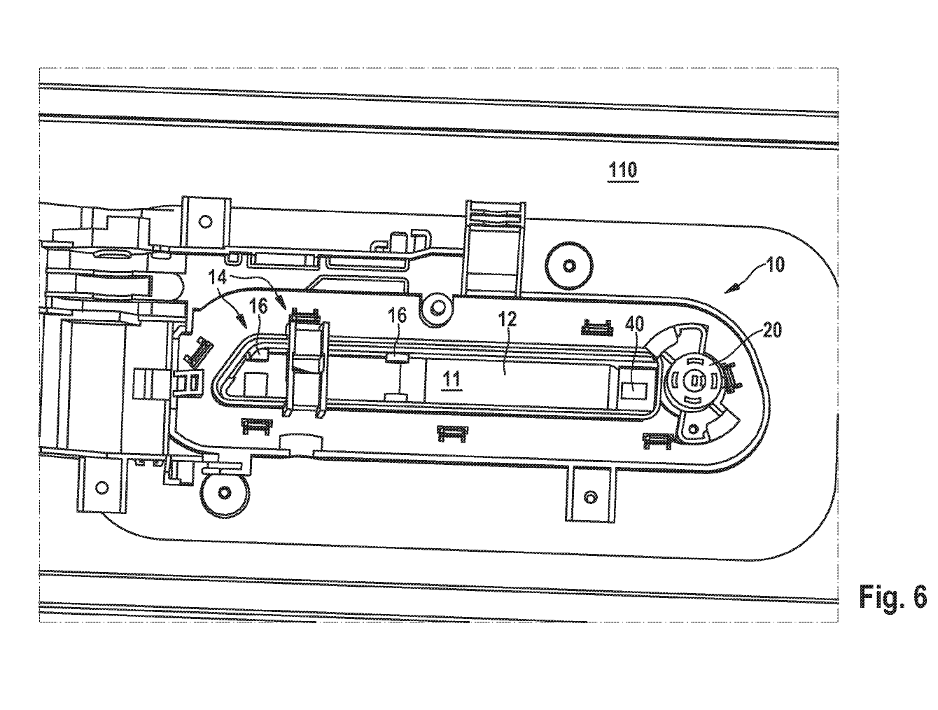

FIG. 6 a rear view of an embodiment of the handle unit according to the invention, and

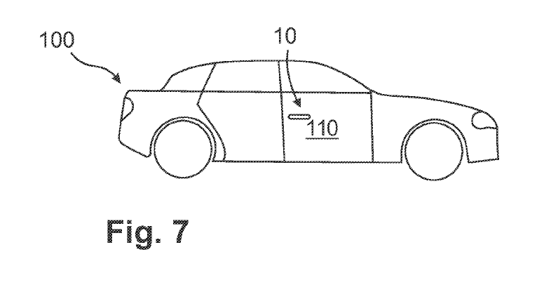

FIG. 7 a vehicle with a door handle system according to the invention and a handle unit according to the invention.

FIG. 1 shows a first embodiment of the handle unit 10 according to the invention on a moveable part 110, wherein the handle portion 11 is shown in the rest position I, where the handle portion 11 is arranged flush with the outer surface 111 of the moveable part 110. A locking cylinder 20 is arranged on the moveable part 110 and behind the handle portion 11. In FIG. 1, the locking cylinder 20 is completely covered by the handle portion 11 of the handle unit 10. Furthermore, the handle portion 11 of FIG. 1 comprises a sensor 40, which in particular can be formed as a proximity sensor, so that an approach of an operator can be sensed on the handle portion 11. According to the invention, the locking cylinder 20 serves in particular as an emergency locking cylinder 20, whereby a lock/locking system of a vehicle 100 is manually mechanically actuatable.

FIG. 2 shows a door handle system 200 according to the invention in a first embodiment, wherein the door handle system 200 comprises a handle unit 10, which is arranged on a moveable part 110 and situated in the operating position II. On the handle portion 11, a cover element 30 and an access opening 21 is arranged. The cover element 30 comprises an opening aid 31 in the form of a corrugation 31 on a portion of the cover element 30, which portion can be grasped by an operator. The handle unit 10 comprises a locking cylinder 20, in particular an emergency locking cylinder 20, on the moveable part 110. The locking cylinder 20 is arranged behind the cover element 30 of the handle portion 11 here. FIG. 2 further shows the emergency key 210, which consists of a key bow 212 and a key bit 211 and is configured to be foldable. Furthermore, the handle portion 11 comprises a housing 11.1, wherein a handle recess 12 is arranged on the housing 11.1 of the handle portion 11, whereby the handle portion 11 can be grasped by a user.

FIG. 3 shows another exemplary embodiment of a handle unit 10 according to the invention, wherein the handle portion 11 is in the operating position II. The handle portion 11 comprises a housing 11.1 and a handle recess 12. Furthermore, a sealing element 11.2 is arranged on the outer surface 111 of the moveable part 110 in the region of the handle unit 10, so that the handle portion 11 can be closed in a sealed manner with the outer surface 111 of the moveable part 110 when the handle portion 11 is in the rest position I. The handle portion 11 further comprises a sensor 40 in FIG. 3, which is arranged in such a way that a recognition area results on the side facing away from the vehicle 100, so that in particular an approach of a user to the handle unit 10 can be sensed. Moreover, the handle portion 11 comprises a cover element 30 with an opening aid 31, wherein the opening aid 31 is formed as a corrugated surface of the cover element 30. The cover element 30 is arranged on the handle portion 11 in such a way that the locking cylinder 20 located behind it is not accessible for the operator.

FIG. 4 shows the handle unit 10 according to the invention in a door handle system 200 according to the invention, wherein the handle portion 11 comprises a sealing element 11.2, so that the handle portion 11 is arrangeable in a manner sealing with the outer surface 111 of the moveable part 110. In the shown actuating position III, the handle unit 11 is spaced apart from the outer surface 111 of the moveable part 110 in such a way that the cover element 30, as shown in the illustration, is removable from the housing 11.1 of the handle portion 11. In FIG. 4, the cover element 30 is formed essentially U-shaped and further comprises a securing element 32, which is connected in the form of an elastic, rope-like connection to the handle portion 11. On the cover element 30, furthermore an opening aid 31 in the form of a corrugation is arranged, so that the cover element 30 can be pulled-off laterally from the handle portion 11. This releases the locking cylinder 20 located behind it, so that the emergency key 210 can be inserted into the locking cylinder 20, at least with the key bit 211 in the locking cylinder 20. Accordingly, the access opening 21 is unblocked in such a way that the emergency key 210 is arrangeable in the locking cylinder 20 and actuatable or lockable or unlockable by a turn movement. Furthermore, the handle unit 10 comprises a stop element 15, which is arranged in the region of the outer surface 111 of the moveable part 110, so that the handle portion 11 or the housing 11.1 of the handle portion 11 can be brought into contact with the stop element 15, in particular when the handle portion 11 is in the rest position I.

FIG. 5 shows a detail of a door handle system 200 according to the invention with a door handle unit 10 and an emergency key 210, which is arranged in the locking cylinder 20. The emergency key 210 comprises a key bow 212 and a key bit 211, wherein the key bit 211 is arranged in the locking cylinder 20 and the key bow 212 is arranged moveable on the key bow 211 and is arranged in a manner offset by an angle or rotated to the key bit 211. The access opening 21 enables, due to the removable cover element 30, that the emergency key 210 is insertable in the locking cylinder 20, and thus the locking cylinder 20 is lockable or unlockable. Furthermore, the handle unit 10 in FIG. 5 comprises a handle portion 11 with a housing 11.1, wherein a handle recess 12 is arranged on the handle portion 11.

FIG. 6 shows a further embodiment of a handle unit 10 according to the invention on a moveable part 110 from a side facing away from the vehicle 100, so that the handle unit 10 and the locking cylinder 20 are shown from the rear side. The handle mechanism 14 comprises two mounting points 16, whereby the handle portion 11 is moveable mounted.

FIG. 7 shows a vehicle 100 with a door handle system 200 according to the invention and a handle unit 10 according to the invention, which is arranged in a moveable part 110 in the form of a vehicle door 110.

### LIST OF REFERENCE CHARACTERS

10 Handle Unit
11 Handle portion
11.1 Housing
11.2 Sealing element
12 Handle recess
13 Reach-through opening
14 Handle mechanism
15 Stop element
16 Mounting points
20 Locking cylinder
21 Access opening
30 Cover element
31 Opening aid
32 Securing element
33 Pivot mechanism
34 Latch connection
35 Clip connection
40 Sensor
100 Vehicle
110 Moveable part
111 Outer surface
200 Door handle system
210 Emergency key
211 Key bit
212 Key bow
I Rest position
II Operating position
III Actuating position

1.-21. (canceled)

22. A handle unit for a moveable part of a vehicle, the handle unit comprising: a locking cylinder and a moveably-mounted handle portion with a housing, wherein the handle portion can at least be brought into a rest position, in which the handle portion is arranged flush with an outer surface of the vehicle, and into an operating position, in which the handle portion is at least sectionally arranged spaced apart from the outer surface and can be grasped by a user.

23. The handle unit according to claim 22, wherein in the rest position, the locking cylinder is covered by the handle portion.

24. The handle unit according to claim 22, wherein the handle portion comprises an access opening, whereby the locking cylinder is accessible from outside at least in the operating position, wherein a cover element is arrangeable, so that the access opening can be closed by the cover element.

25. The handle unit according to claim 22, wherein the cover element at least sectionally surrounds the locking cylinder in the rest position.

26. The handle unit according to claim 22, wherein the handle portion can be brought into an actuating position from an operating position, wherein the cover element is releasable from the housing of the handle portion at least in the actuating position or the operating position.

27. The handle unit according to claim 22, wherein the access opening is arranged on a broadside of the handle portion.

28. The handle unit according to claim 22, wherein the cover element comprises at least one of at least one latch connection or clip connection, whereby a force-fit connection to the housing can be produced.

29. The handle unit according to claim 22, wherein the cover element comprises a pivot mechanism, whereby the cover element is moveable in a translatory and rotary manner and the access opening is thereby releasable and closeable.

30. The handle unit according to claim 22, wherein the handle portion comprises a handle recess or a reach-through opening.

31. The handle unit according to claim 22, wherein the handle portion or the cover element is an injected molded plastic part.

32. The handle unit according to claim 22, wherein the cover element is arranged flush with the housing.

33. The handle unit according to claim 22, wherein a handle mechanism is provided, whereby the handle portion is moveable in a translatory manner or along a circular path.

34. The handle unit according to claim 22, wherein at least one sensor is provided.

35. The handle unit according to claim 22, wherein at least one opening aid is arranged on the cover element, allowing a simplified removal of the cover element.

36. The handle unit according to claim 22, wherein the handle mechanism comprises a push-push-mechanism, whereby the handle portion can mechanically be brought from the rest position at least into the operating position or actuating position.

37. The handle unit according to claim 22, wherein the cover element comprises a securing element, whereby the cover element is mechanically connected to at least the handle portion or the moveable part.

38. The handle unit according to claim 22, wherein a sealing element is provided.

39. The handle unit according to claim 22, wherein a locking cylinder is provided, wherein the locking cylinder is at least sectionally arranged in the access opening and covered by the housing in the rest position.

40. The handle unit according to claim 22, wherein a stop element is provided, wherein the handle portion at least sectionally contacts the stop element in the rest position, whereby the position of the handle portion can be sensed.

41. The handle unit according to claim 22, wherein the side of the handle portion facing away from the vehicle is arrangeable, in the operating position, spaced apart from the outer surface by between approximately 10 mm and approximately 75 mm, preferably between 20 mm and 55 mm.

42. A door handle system for a vehicle comprising at least one handle unit for a moveable part of a vehicle, comprising a locking cylinder and a moveably-mounted handle portion with a housing, wherein the handle portion can at least be brought into a rest position, in which the handle portion is arranged flush with an outer surface of the vehicle, and into an operating position, in which the handle portion is at least sectionally arranged spaced apart from the outer surface and can be grasped by a user, and at least one emergency key, wherein the emergency key is formed in multiple parts.
